(19) United States
(12) Patent Application Publication
(10) Pub. No.: US 2019/0336894 A1
(43) Pub. Date: Nov. 7, 2019

(54) SCREENING DEVICE HAVING PIVOTABLE SCREENING PANELS

(71) Applicant: AQSEPTENCE GROUP GMBH, Aarbergen (DE)

(72) Inventor: Klaus HEIL, Schweigen-Rechtenbach (DE)

(73) Assignee: AQSEPTENCE GROUP GMBH, Aarbergen (DE)

(21) Appl. No.: 16/515,863

(22) Filed: Jul. 18, 2019

Related U.S. Application Data
(63) Continuation of application No. PCT/EP2018/050123, filed on Jan. 3, 2018.

(30) Foreign Application Priority Data
Jan. 18, 2017 (DE) 10 2017 100 952.3

(51) Int. Cl. B01D 33/333; B01D 33/46

(52) U.S. Cl. CPC B01D 33/333; B01D 33/463

(57) ABSTRACT

A screening device having screening panels which are oriented transversely to the flow direction of a stream of liquid and each have a screening surface and form a circulating continuous screening belt which can be immersed in the stream of liquid. The successive screening panels form a common screening surface in the sluice channel, wherein the circulatory motion of the continuous screening belt is kept substantially completely within a single plane. The pivot axes about which the screening panels are pivoted at return points of the continuous screening belt are perpendicular to the common screening surface. The screening surfaces of the screening panels have a plurality of recesses and/or elevations running adjacent to one another over the screening surface.

This nonprovisional application is a continuation of International Application No. PCT/EP2018/050123, which was filed on Jan. 3, 2018, and which claims priority to German Patent Application No. 10 2017 100 952.3, which was filed in Germany on Jan. 18, 2017, and which are both herein incorporated by reference.

### BACKGROUND OF THE INVENTION

### Field of the Invention

The present invention relates to a screening device for mechanically separating and extracting solid elements, solid bodies or solid matter from the stream of liquid of a liquid flowing in a sluice channel, in particular, to a screen or filter grating for process, cooling water or effluent currents or in sewage treatment plants or for use in hydroelectric power stations.

### Description of the Background Art

Such screening devices usually have a number of screening panels, which are substantially oriented transversely to the flow direction of the stream of liquid, each screening panel having a screening surface with a plurality of screening surface openings, wherein the screening panels form a circulating continuous screening belt, which can be partially immersed in the stream of liquid and in which a number of successive screening panels arranged adjacent to one another in the direction of motion of the continuous screening belt form a common screening surface in the sluice channel, said devices also having a drive for driving the continuous screening belt in a circulatory motion, which preferably enables continuous separation and extraction of the solid matter from the stream of liquid. Generally, in so-called transverse flow implementations, the continuous screening belt completely covers the cross-section of the stream of liquid or is at least secured by lateral seals against a flow around it. Consequently the solid matter cannot pass through the screening device, as long as its dimensions are larger than the gap or mesh size of the screening panels. It thus is deposited on the screening surfaces of the screening panels.

The solid matter that has been deposited on the stream of liquid at the screening panels is carried upwards by the circulatory motion of the continuous screening belt and discharged, removed or cleaned off from the screening panels at a discharge point located above the water level. By spraying off the screening panels at the discharge point, the screening panels can be thoroughly cleaned before they are re-immersed in the stream of liquid.

Such screening devices are known in various configurations, which are named “transverse flow”, “from in to out” or “from out to in”. One example of a transverse flow screening device is known from DE 197 27 354 A1. It has screening panels that are arranged successively in the continuous screening belt in such a way that the circulatory motion of the continuous screening belt takes place in two parallel planes spaced at a distance from one another, wherein the screening panels in the plane lying upstream are carried upwards out of the sluice channel and those in the plane lying downstream are moved downwards into the sluice channel. The screening panels are pivoted at the highest and lowest point about pivot axes of the continuous screening belt lying transversely to the sluice channel in a plane parallel to the water level, i.e. transversely to the flow direction in a plane parallel to the screening surfaces. The screening surface of the screening panels has an inclined front and an inclined rear screening surface portion, which are connected by a central, flat screening surface portion. This construction increases the stability of the screening panels. Furthermore, in the flat trough, which is formed by the rear screening surface portion of a screening panel with the front screening surface portion of a following screening panel in the direction of circulation, solid matter particles can be taken up and discharged, which contributes to an overall improvement of the screening capacity of the screening device, but not of the screening capacity of the individual screening panels themselves.

From DE 39 28 681 A1 a non-generic screening device is known, provided not for extracting debris from a stream of liquid in a sluice channel, but for a sewage pond. This device does not have a plurality of screening panels forming a common screening surface, but just one screening panel which is not immersed in a stream of liquid in a circulatory motion nor lifted out of this. Rather it is arranged in a stationary manner in the sewage pond. The screening surface of the statically arranged screening panel is configured in the manner of folds to increase its useful surface.

A particular embodiment of a screening device, to the further development of which the invention is directed, is known from WO 01/08780 A1. It has screening panels, which are arranged successively in the continuous screening belt in such a way that the circulatory motion of the continuous screening belt is kept substantially completely within a single plane, wherein the pivot axes, about which the screening panels are pivoted at return points of the continuous screening belt, lie perpendicular to the common screening surface. The screening panels through which the stream of liquid flows are flat. For extracting the debris or solid matter falling off of the screening panels from the liquid and thereby improving the screening capacity of the overall screening device, they may have at their rear end in the direction of motion a debris pocket which can be formed, for example, by a fold of a profile frame. Such debris pocket, however, does not improve the screening effect of the screening panels, as the stream of liquid does not flow through the debris pocket.

Compared with the other known embodiments, the screening device known from WO 01/08780 A1 has multiple advantages. In practice, however, the device still needs to be improved, in particular with respect to the smallest possible pressure loss in the stream of liquid.

### SUMMARY OF THE INVENTION

It is therefore an object of the present invention to create a screening device which combines the smallest possible loss of pressure in the stream of liquid with a small construction length of the screening device, when seen in the flow direction of the stream of liquid, and a simple design of the continuous screening belt.

Thus, a screening device according to the invention for mechanically separating and extracting solid elements, solid bodies or solid matter from the stream of liquid of a liquid flowing in a sluice channel, in particular a screen or filter grating for process, cooling water or effluent currents or in sewage treatment plants or hydroelectric power stations, with a number of screening panels which are substantially oriented transversely to the flow direction of the stream of liquid, and which each have a screening surface with a plurality of screening surface openings, wherein the screening panels form a circulating, continuous screening belt, which can be partially immersed in the stream of liquid and in which a number of successive screening panels arranged adjacent to one another in the direction of motion of the continuous screening belt form a common screening surface in the sluice channel, the screening device also comprising a drive for driving the continuous screening belt in a circulatory motion, wherein the screening panels are arranged successively in the continuous screening belt in such a way that the circulatory motion of the continuous screening belt is kept substantially completely within a single plane, and wherein the pivot axes, about which the screening panels are pivoted at return points of the continuous screening belt, lie perpendicular to the common screening surface, said screening device has the special feature that it comprises screening panels, the screening surface of which has a plurality of recesses and/or elevations running adjacent to one another across the screening surface.

In contrast to the screening device known from WO 01/08780 A1, the screening panels of a screening device according to the invention do not have a smooth or level screening surface, but rather a plurality of recesses and/or elevations running adjacent to one another across the screening surface. The recesses can also be described as screening surface valleys and the elevations as screening surface crests or screening surface peaks. They can be configured on the inflow side (dirty water side) or on the outflow side (clean water side) of the screening panels or on both sides. The invention has the advantage that the orientation of the recesses and/or elevations, i.e. the direction of their longitudinal extension, can be transverse (i.e. horizontal), parallel (i.e. vertical) or at an angle to the direction of motion of the continuous screening belt relative to the orientation of the screening panels on their upward motion in the continuous screening belt out of the liquid in the sluice channel. Embodiments with a combination of one or more of these orientations are also possible, both with regard to the configuration of the screening surface of a screening panel and with regard to the entire screening device, which in particular embodiments may have screening panels with differently oriented recesses and/or elevations, in order to form a screening device that is optimized by the different screening panels, for example for a special fish protection or for a special retaining characteristic for different components to be separated and extracted from the stream of liquid. The screening device according to the invention can thus be configured very variably for the respective application.

In a screening device preferably all screening panels comprise recesses and/or elevations. In particular embodiments, however, single or multiple screening panels according to the prior art, i.e. screening panels with smooth or level screening surfaces, may be provided. Thus also in this regard the screening device according to the invention can be adapted very variable to the respective application.

The recesses and/or elevations running over the screening surface form a kind of folding of the screening surface. An advantage is that due to this folding the screening surface is larger than a screening device with a smooth or level surface of the same outer dimensions. Due to the shaping of the screening surface, the effective screening surface of a screening panel is enlarged. Since the throughput through the screening device is equal to the product of flow velocity of the stream of liquid and overall screening surface of the screening device, the throughput in a screening device according to the invention is thus increased at the same size of the screening device. Consequently, to achieve a predetermined throughput, the screening device and the associated structure in the sluice channel may be configured smaller as compared to the prior art, thus reducing the construction costs for the user.

The variable design of the screening panels and a higher throughput are, however, not the only advantages of the screening device according to the invention. It also has, as described below, additional specific advantages as compared to a generic screening device.

One of these advantages is a higher debris removal of solid elements, solid bodies or solid matter from the stream of liquid. The elevations and/or recesses on a screening surface act as multiple individual debris carriers for debris deposited on the screening surface, which debris does not slide downwards on the screening surface, but forms a debris mat held by the screening surface. This results in a higher degree of loading of the screening surfaces with debris, i.e. on a screening surface with elevations and/or recesses more debris can be deposited than on a level or smooth screening surface and then, during the circulatory motion of the continuous screening belt, be conveyed by the screening panel out of the stream of liquid. This advantage results in particular, but not exclusively, with an orientation of the recesses and/or elevations, i.e. the direction of their longitudinal extension, which is transverse to the direction of motion of the continuous screening belt (i.e. horizontal) relative to the orientation of the screening panels in their upward movement in the continuous screening belt out of the liquid in the sluice channel.

Another specific advantage is a reduced hydraulic resistance of the screening device to the stream of liquid. As described above, due to the plurality of elevations and/or recesses acting as debris carriers the debris particles do not slide downwards on the screening surface and collect at the lower edge of the screening surface, thus resulting in an evenly distributed debris load over the entire screening surface of a screening panel. On account of the uniformly distributed debris load, there are no locally excessive or locally much diversified flow velocities in the screening surface, which results in less turbulence. This has the advantage both of a lower hydraulic resistance of the screening device in the sluice channel and of a lower dissolution of debris from the screening surface because of flow turbulences. This in turn improves debris removal.

Another specific advantage is the higher stability of the screening panels and screening surfaces. With a design according to the invention, the screening panels and screening surfaces are stiffened, so that adequate strength is achieved even for very high water pressures. The screening device according to the invention can therefore be used even in applications that would not be feasible with a generic screening device with a high water pressure. The higher stability of the screening panels and screening surfaces also has the advantage that the screening panels and the screening surfaces can be constructed from less heavy or solid material, so that both a material saving and an improvement in the throughflow are achieved. If the screening surfaces are configured as wire fabric, for example, the wire fabric is stiffened due to the design according to the invention. The use of thinner wires—upon maintaining the same strength—not only results in material saving but also in an enlargement of the surface freely available for the throughflow.

Another specific advantage includes an effective cleaning of the screening panels. Generally, the debris adhering to the screening surfaces and extracted from the stream of liquid is removed by spraying of the screening panels of the continuous screening belt lifted out of the stream of liquid by means of water or compressed air spray jets, whereupon the debris is received by a debris collecting sluice channel arranged on the side of the continuous screening belt opposite to the spray jets. Due to the inclined flanks of the elevations and/or recesses in the screening surfaces, the debris sprayed off is guided in the direction of the debris collecting sluice channel, the flanks serving as a ramp to direct the debris to the debris collecting sluice channel. In this way a higher proportion of the sprayed-off debris is collected by the debris collecting sluice channel.

The invention also has specific advantages with respect to fish protection. The problem with generic screening devices is that not only solid elements, solid bodies or solid matter accumulate in the screening panels and are screened out and removed from the sluice channel by the screening device. Also aquatic species such as fish, crabs, larvae etc. are caught in the screening surfaces of the screening panels or in solid matter deposited thereon and thus are screened out of the sluice channel together with this solid matter. In a screening device according to the invention, the impact of fish on the screening panels is tempered on account of the inclined flanks of the elevations and/or recesses of the screening panels, so that they are less frequently injured or killed.

To enable the gentlest possible treatment of aquatic species extracted from the sluice channel by the screening device and to facilitate their return to the sluice channel, a screening device according to the invention may also comprise screening panels, each having, on the inflow side thereof, a fish-lifting trough, the fish-lifting trough being arranged and designed such that, with respect to the screening panels moving upwards it is located at the lower end, with respect to the screening panels moving upwards it forms in each case a liquid-filled collecting recess for aquatic animals located in the particular screening panel, which collecting recess is lifted, in the movement direction of the continuous screening belt, out of the stream of liquid together with the screening panel, together with the liquid contained in the collecting recess and together with aquatic animals caught in the liquid, when the continuous screening belt moves, and is emptied out into a collecting channel in the upper return area of the continuous screening belt, in an emptying area of the screening device, by tipping the screening panel and the collecting recess, the cleaning area of the screening device, which has a device for cleaning the debris from the screen surfaces, being arranged so far behind the emptying area in the movement direction of the continuous screening belt that the collecting recesses are emptied before they reach the cleaning area. Fish screened out of the sluice channel with the screening device can hereby be returned to the sluice channel.

This advantage arises in particular, but not only, when the orientation of the recesses and/or elevations, i.e. the direction of their longitudinal extension, is roughly parallel to the direction of motion of the continuous screening belt (i.e. vertical), relative to the orientation of the screening panels in the continuous screening belt in their upward movement out of the liquid in the sluice channel, because in this case the fish slide and can be guided along the longitudinal extension of the recesses or elevations into the collection recess during the upward movement of the screening panels, and when the recesses or elevations thereafter are arranged essentially horizontally in the emptying area, so that the flanks of the elevations or recesses form a gentle guiding ramp for the fish to the collecting channel.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a schematic frontal view of a screening device,

FIG. 2 is an exemplary embodiment of a continuous screening belt shown in FIG. 1,

FIG. 3 is an exemplary embodiment of a continuous screening belt shown FIG. 1,

FIG. 4 shows a detail of the continuous screening belt shown in FIG. 2 from a straight section of the continuous screening belt,

FIG. 5 shows a detail of the continuous screening belt shown in FIG. 2 from the lower deflection area of the continuous screening belt,

FIG. 6 shows a detail of the continuous screening belt shown in FIG. 3 from a straight section of the continuous screening belt,

FIG. 7 shows a detail of the continuous screening belt shown in FIG. 3 from the lower deflection area of the continuous screening belt,

FIG. 8 shows a screening panel of the continuous screening belt of FIG. 2,

FIG. 9 shows the screening surface of the screening panel of FIG. 8,

FIG. 10 shows a screening panel of the continuous screening belt of FIG. 3,

FIG. 11 shows the screening surface of the screening panel of FIG. 10,

FIG. 12 shows a detail of FIG. 6,

FIG. 13 shows the profile of a screening surface folded in a wavelike manner,

FIG. 14 shows the profile of a screening surface folded in a wavy manner or in the manner of an involute,

FIG. 15 shows the profile of a screening surface folded in a sawtooth-like manner, and

FIG. 16 shows the profile of a screening surface folded trapezoidally.

### DETAILED DESCRIPTION

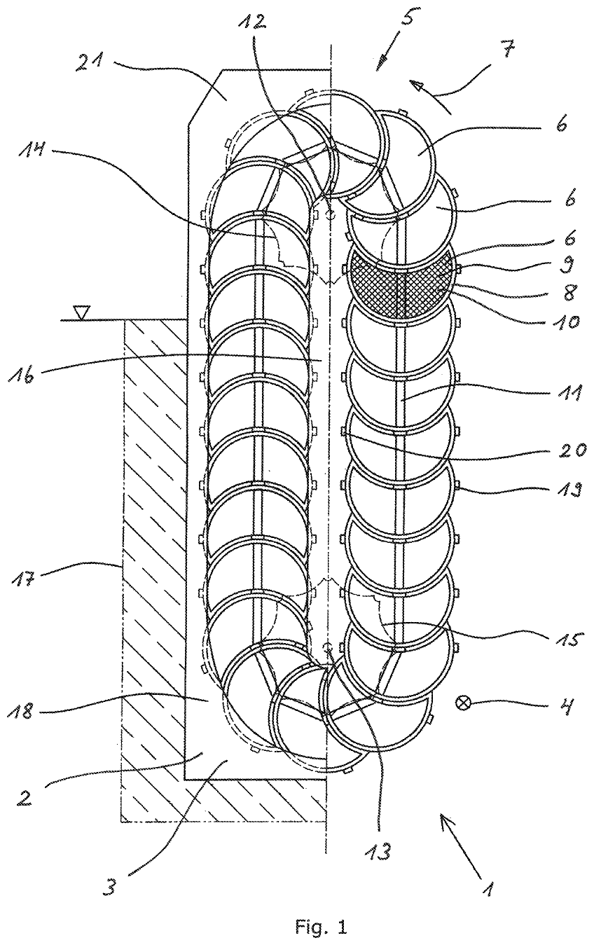

FIG. 1 illustrates a screening device 1 according to the invention based on a generic screening device according to WO 01/08780 A1, which corresponds to U.S. Pat. No. 6,719,898, which is incorporated herein by reference. It shows a diagrammatic frontal view of a screening device 1 according to the invention for mechanically separating and extracting solid elements, solid bodies or solid matter from the stream of liquid 2 of a liquid flowing in a sluice channel 3 in the flow direction 4 with a continuous screening belt 5, wherein the right-hand half of FIG. 1 shows the continuous screening belt 5 without other components of the screening device 1 and without its environment. The continuous screening belt 5 is arranged transversely to the flow direction 4, the stream of liquid 2 flowing perpendicularly to the drawing plane through the continuous screening belt 5. The continuous screening belt 5 comprises a number of screening panels 6 substantially oriented transversely to the flow direction 4 of the stream of liquid 2, these panels forming the circulatory continuous screening belt 5 which can be partially immersed in the stream of liquid 2. In the continuous screening belt 5 the successive screening panels 6 arranged adjacent to one another in the direction of motion of the continuous screening belt 5 form a common screening surface in the sluice channel 3.

The geometry of the screening device 1 is preferably chosen such that the part of the circulating continuous screening belt 5 moving upwards and the part of the circulating continuous screening belt 5 moving downwards each cover roughly a right and left half of the stream of liquid 2. The stream of liquid 2 flows in the flow direction 4 through the screening device 1 and the screening panels 6 immersed in the stream of liquid 2, respectively, during which the stream of liquid 2 is cleaned by screening.

The screening device 1 comprises a drive for driving the continuous screening belt 5 in a circulatory motion 7, the direction of which is illustrated by the arrow. The screening panels 6 are arranged successively in the continuous screening belt 5 in such a way that the circulatory motion 7 of the continuous screening belt 5 is kept substantially completely within a single plane, and wherein the pivot axes, about which the screening panels 6 are pivoted at return points of the continuous screening belt 5, lie perpendicular to the common screening surface. The plane of the circulatory motion 7 of the screening panels 6 is preferably arranged so as to be substantially perpendicular to the flow direction 4 of the stream of liquid 2, meaning that the pivot axes, about which the screening panels are pivoted at return points of the continuous screening belt and which lie perpendicular to the common screening surface, are oriented parallel to the flow direction 4 of the stream of liquid 2, and the screening device 1 or the plane wherein the circulatory motion 7 of the continuous screening belt 5 is kept, and the common screening surface are arranged vertically in the sluice channel 3. Instead of the preferably vertical arrangement in the sluice channel 3, in particular embodiments the screening device 1 can also be arranged at an angle.

The screening panels 6 each comprise a screening panel frame 8 and a screening surface 9 supported by the screening panel frame 8, which surface has a plurality of screening surface openings 10. For reasons of clarity the screening surface openings 10 are shown only on one of the depicted screening panels 6.

In FIG. 1 the screening panels 6 are crescent-shaped, meaning substantially a shape in which the front end and rear end of a screening panel 6, viewed in the direction of the circulatory motion 7 of the screening panels 6, has the contour of a section of a circular arc, wherein the radii of the circles forming the outer contour at the front and rear end are preferably the same. This embodiment has the advantage that the successively arranged screening panels 6 lying in permanent contact adjacent to one another along the outer contour formed by the circular sections, with a small gap space to one another or sealed together by sealing elements, cannot only be moved in a straight line but also be deflected around a deflection, without a gap forming between adjacent screening panels 6 through which liquid could pass unscreened when the direction of motion of the screening panels 6 changes, for example at the deflection.

According to a first embodiment, shown in FIG. 1, the crescent-shaped screening panels 6 are preferably configured so that their outer contours are each formed by two intersecting sections of two circles with an identical radius, wherein the center point of the first circle, which forms the convex section of the outer contour of the screening panel 6, lies on the second circle, which forms the concave section of the outer contour of the screening panel 6. By means of this geometry the screening panels 6 can be pivoted by their active surface against one another within the plane, without gaps being created between them and without the screening panels 6 being pushed over one another on pivoting; the latter would cause a double overlap of the screening surface which would be disadvantageous with respect to optimization of the pressure loss.

These advantages are also achieved with a second embodiment of the crescent-shaped screening panels 6, wherein the outer contours of the crescent-shaped screening panels 6 are each formed by two non-intersecting sections of two circles of identical radius and two linear or curved connection sections connecting the circular sections. Due to the connecting sections such screening panels 6 are longer than those of the first embodiment. The advantage of such elongated crescent shape is that the number of screening panels 6 in a continuous screening belt 5 of a given length can be reduced.

The screening panels 6 are concatenated by means of connecting elements 11 such that in the circulatory motion 7 in the section arranged on the right-hand side of this view, they are lifted upward from the stream of liquid 2 in the drawing plane, deflected at an upper return point 12 of the continuous screening belt 5 within the drawing plane, then immersed downwards into the stream of liquid 2 in the section arranged on the left and are finally deflected again at a lower return point 13 of the continuous screening belt 5, still in one and the same drawing plane, in order to form a closed continuous screening belt 5. In the simplest case the geometry of the continuous screening belt 5 for its circulatory motion is formed in such a way that the screening panels 6 dip into the stream of liquid 2 and are lifted out from this stream of liquid 2 in a respectively linear movement, wherein they are deflected at an upper return point 12 and at a lower return point 13 with a substantially circular motion. The articulated connection between the individual screening panels 6 by means of the connecting elements 11 is thus designed so that the individual screening panels 6 are pivotable against one another within the active plane of the continuous screening belt 5.

The screening panels 6 are pivoted against one another at the return points 12, 13 in such a way that the pivot axis lies perpendicular to the drawing plane. The connecting elements 11 are part of a chain, which serves to drive the continuous screening belt 5, and are deflected at an upper chain sprocket 14, which is motor-driven, and at a lower chain sprocket 15. The chain sprockets 14, 15 shown in the example each have eight teeth; in other embodiments a larger or smaller number of teeth can also be provided, depending on the radius of the deflection and the dimensions of the screening panels 6.

It is generally advantageous if the drive of the continuous screening belt 5 comprises a drive chain, which runs at an upper deflection of the continuous screening belt 5 over an upper chain sprocket 14 and at a lower deflection over a lower chain sprocket 15, as a chain drive represents a preferred embodiment for a drive of the continuous screening belt 5. In this case the upper chain sprocket 14 may advantageously be driven by a drive motor.

For stability reasons the screening device 1 comprises a guide device, in which at least a number of screening panels 6 are guided laterally. For this purpose in FIG. 1 a fixed center guide member 16 is arranged between the linear sections running upwards and downwards of the illustrated continuous screening belt 5, which member delimits the continuous screening belt 5 inwardly. The center guide member 16 can be anchored fixedly for stability reasons in the area of its lower end, so that it does not yield to the flow pressure of the stream of liquid 2. The center guide member 16 has the advantage that at least a portion of the screening panels 6 can be guided in it, which advantageously increases the stability of the overall device. Screening panels 6 can be guided in the center guide member 16. The guidance can, for example, take place in a sliding manner or by means of inner rotatable guide elements, e.g. guide rollers or balls, arranged on the screening panels 6 or on their connecting elements 11.

At least some of the screening panels 6 should be guided in a guide device arranged laterally, preferably along the outer wall 17 delimiting the stream of liquid 2, to avoid a gap between the continuous screening belt 5 and the outer wall 17 due to the flow pressure of the stream of liquid 2, through which gap the liquid would pass without any cleaning effect. This guide is expediently embedded into the outer wall itself. The guidance can take place in a sliding manner, for example, or by means of outer rotatable guide elements such as guide rollers or balls mounted on the screening panels 6 or connecting elements 11.

In FIG. 1, the delimiting of the stream of liquid 2 outwardly is formed by the outer wall 17. This outer wall 17 comprises edge-placed groove-shaped guides 18. The screening panels 6 are guided laterally by outer guide rollers 19 in the area of the outer wall 17 or guide 18 and by inner guide rollers 20 in the area of the center guide member 16. The guides 18 widen in the lower deflection area of the continuous screening belt 5 into flow screens, to prevent a flow around the screening panels 6. At the top the continuous screening belt 5 and the associated drive and cleaning units are provided with a cover 21.

As is clearly recognizable by means of FIG. 1, the screening panels 6 dip so far into the guide 18 and into the center guide member 16 that the gaps at the edge that are present in the continuous screening belt 5 on account of the crescent shape of the screening panels 6 are covered by the guide 18 and the center guide member 16. As a result, the common screening surface of the continuous screening belt 5 resulting from the sum of the screening panels 6 covers the free cross-section of the stream of liquid 2 substantially completely.

Another advantageous feature can include in providing screening belt support elements for stability reasons, which elements are arranged on the clean water side of the continuous screening belt 5, preferably in the area of the center line of screening panels 6. They can be used to absorb the flow-induced force bearing down on the screening panels 6 and to support the screening panels 6. Cross struts can also be provided advantageously in this case between the support elements or to the walls or the bottom of the sluice channel 3 to guarantee secure support of the continuous screening belt 5. The screening belt support elements and the cross struts are thus preferably anchored fixedly to increase the stability of the screening device 1.

The screening panels 6 can be supported on the screening belt support elements in a sliding manner. In a preferred embodiment, rotatable support elements, e.g. support rollers or balls, which permit a more frictionless circulatory motion of the continuous screening belt 5 by rolling, can be provided for supporting the continuous screening belt and the screening panels on a screening belt support element. The rotatable support elements can be mounted on the screening panels 6, for example, or on connecting elements between the screening panels 6.

The screening device 1 according to the invention differs from the generic screening device in that it comprises screening panels 6, the screening surface 9 of which has a plurality of recesses and/or elevations running adjacent to one another over the screening surface 9. The other features of a screening device 1 according to the invention can be configured according to WO 01/08780 A1, to the disclosure of which reference is made in this respect. These other features can relate in particular to the features explained above on the basis of FIG. 1 or the contour, the concatenation, the guidance, the support, the drive or the cleaning of the screening panels 6.

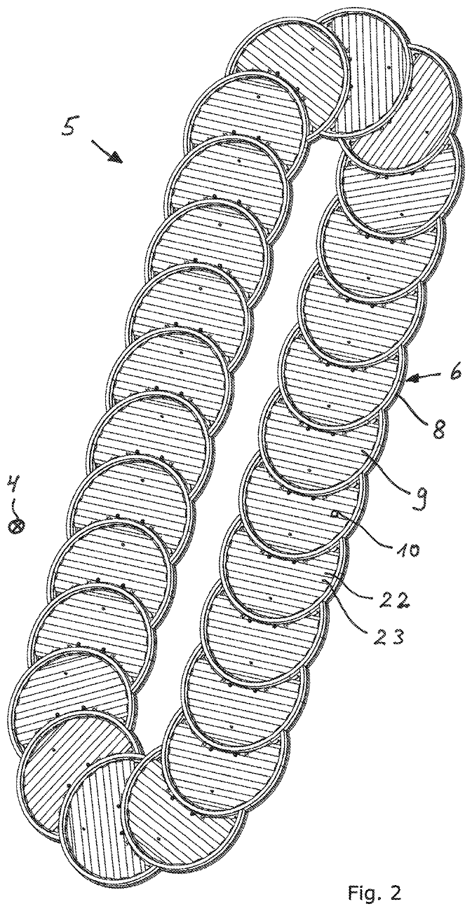

FIG. 2 shows a first exemplary embodiment of a continuous screening belt 5 of the screening device 1 according to FIG. 1, which belt is formed from successive screening panels 6 concatenated with one another. Only the continuous screening belt 5 is shown, without guides or other parts of the screening device 1. In contrast to FIG. 1, the screening panels 6 have no outer guides 19 or inner guides 20 here, but are supported by support elements, e.g. support rollers, on a screening belt support element. The screening device 1 can be optionally equipped with outer guides 19, with inner guides 20, with support elements or with a combination thereof.

For reasons of clarity only one of the many screening surface openings 10 of the screening surface 9 is illustrated schematically in only one of the screening panels 6 depicted, as the screening surface openings 10 are not well represented on this scale and are depicted in other figures showing details. Instead of a smooth or level screening surface 9, the screening panels 6 have a screening surface 9 with a plurality of recesses 22 and/or elevations 23 running adjacent to one another across the screening surface 9. The recesses 22 can also be described as screening surface valleys and the elevations 23 can be described as screening surface crests or screening surface peaks. They can be configured on the upstream side (the dirty water side) or on the downstream side (the clean water side) of the screening panels 6 or on both sides.

The orientation of the recesses 22 and/or elevations 23, i.e. the direction of their longitudinal extension, can be transverse (i.e. horizontal), parallel (i.e. vertical) or at an angle to the direction of motion of the continuous screening belt 5 relative to the orientation of the screening panels 6 on their upward movement in the continuous screening belt 5 out of the liquid in the sluice channel 3. In FIG. 2, this orientation of the recesses 22 and/or elevations 23 is transverse to the direction of motion of the continuous screening belt 5, i.e. they run horizontally during the upward movement of the screening panels 6.

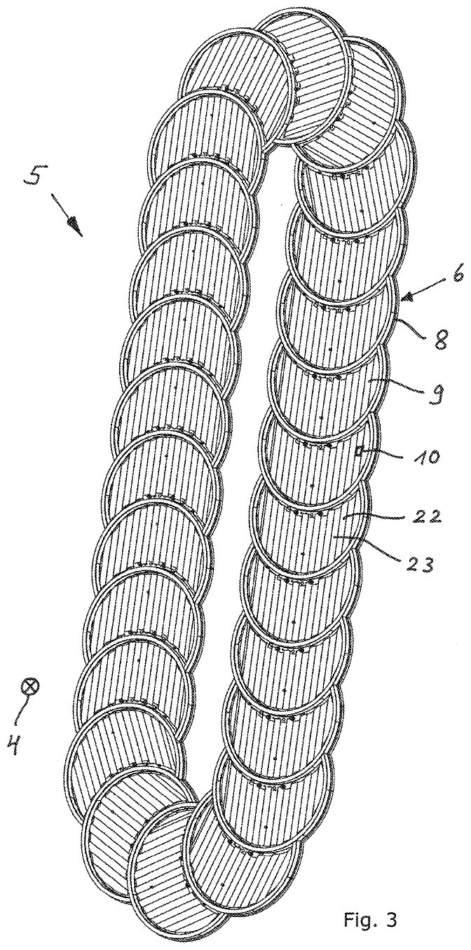

FIG. 3 shows a second embodiment of a continuous screening belt 5 from FIG. 1, in which, in a variation on FIG. 2, the orientation of the recesses 22 and/or elevations 23 is parallel to the direction of motion of the continuous screening belt 5, i.e. they run vertically during the upward movement of the screening panels 6 (in a vertical arrangement of the continuous screening belt 5) or at an angle (in an inclined arrangement of the continuous screening belt 5).

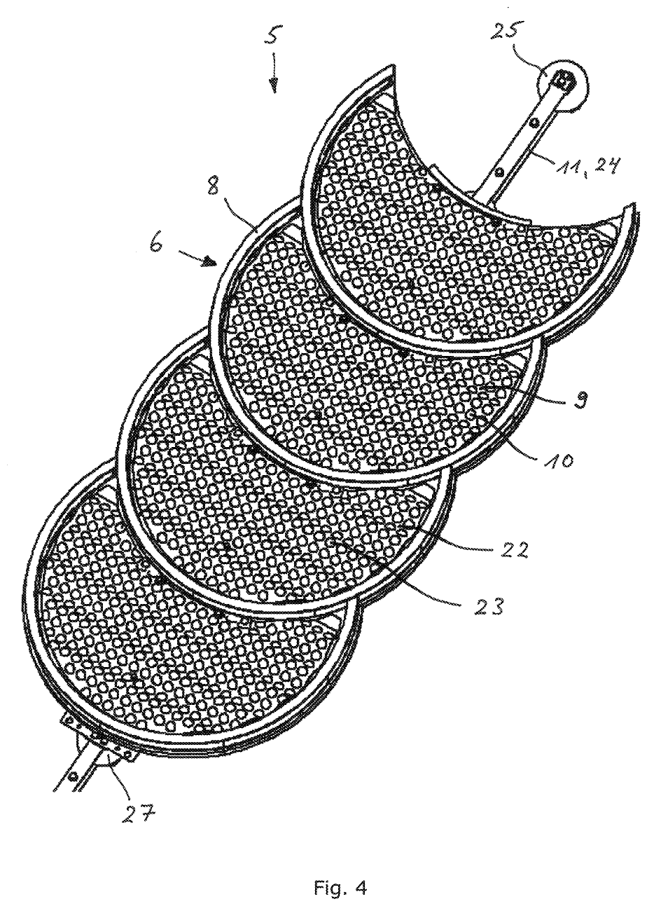

FIG. 4 depicts a detail of the continuous screening belt 5 from FIG. 2 from a straight area of the continuous screening belt 5, to be precise from an area in which the screening panels 6 are in the upward movement, in which they are lifted out from the stream of liquid 2 with debris adhering to them. The screening panels 6 are depicted with the screening panel frame 8 and the screening surfaces 9. An advantageous embodiment of a screening panel 6 includes that it is formed of a screening panel frame 8 and a screening surface 9 held by this. The screening surfaces 9 have screening surface openings 10 as well as a plurality of recesses 22 and elevations 23 running across adjacent to one another the screening surface 9. Also recognizable are chain plates 24, which act as connecting elements 11 for concatenating the screening panels 6, and rollers 25 for guiding the screening panels 6.

Another advantageous feature can include the screening panels 6 having a debris pocket at their rear end in the direction of motion, which can be formed by a bend in a profile frame or a recess, for example, to extract from the liquid also debris or solid matter falling off the screening panel 6.

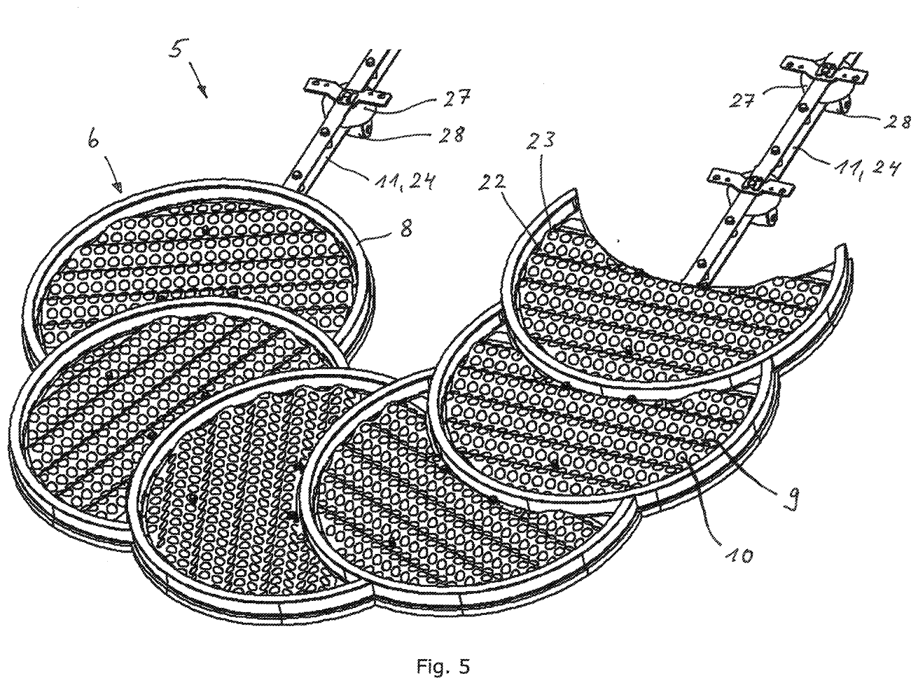

FIG. 5 shows a detail, corresponding to FIG. 4, of the continuous screening belt 5 from FIG. 2 from the lower deflection area of the continuous screening belt 5. It is recognized how the crescent-shaped screening panels 6 are deflected without a gap forming between adjacent screening panels 6 through which liquid could pass unscreened. The recesses 22 and elevations 23 running across the screening surfaces 9 maintain their relative orientation on or opposite the screening panels 6 during deflection, i.e. they change their orientation corresponding to the screening panels 6.

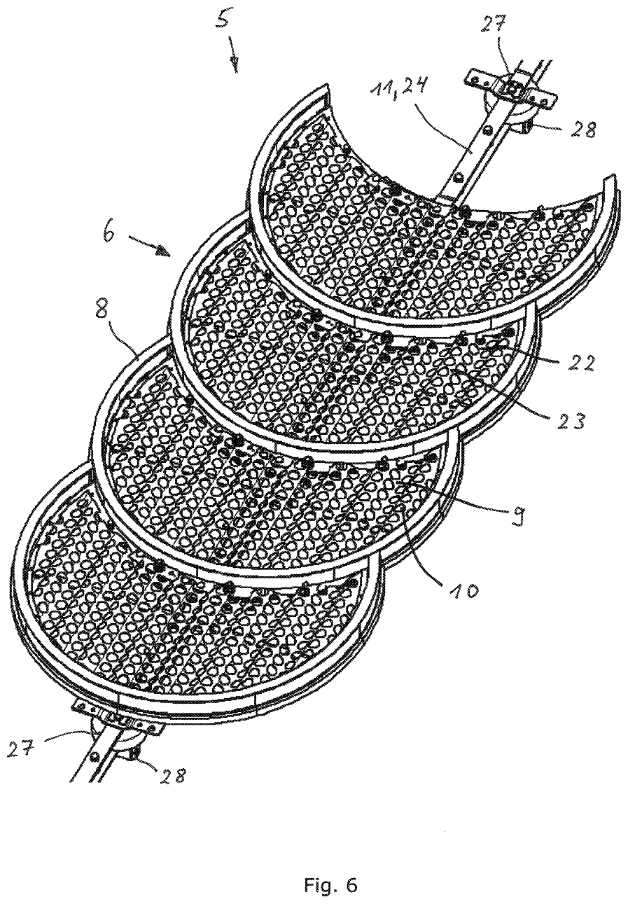

FIG. 6 shows a detail, corresponding to FIG. 4, of the continuous screening belt 5 from FIG. 3 from a straight area of the continuous screening belt 5, wherein as a variation on FIG. 4 the orientation of the recesses 22 and the elevations 23 is parallel to the direction of motion of the continuous screening belt 5 during the upward movement of the screening panels 6.

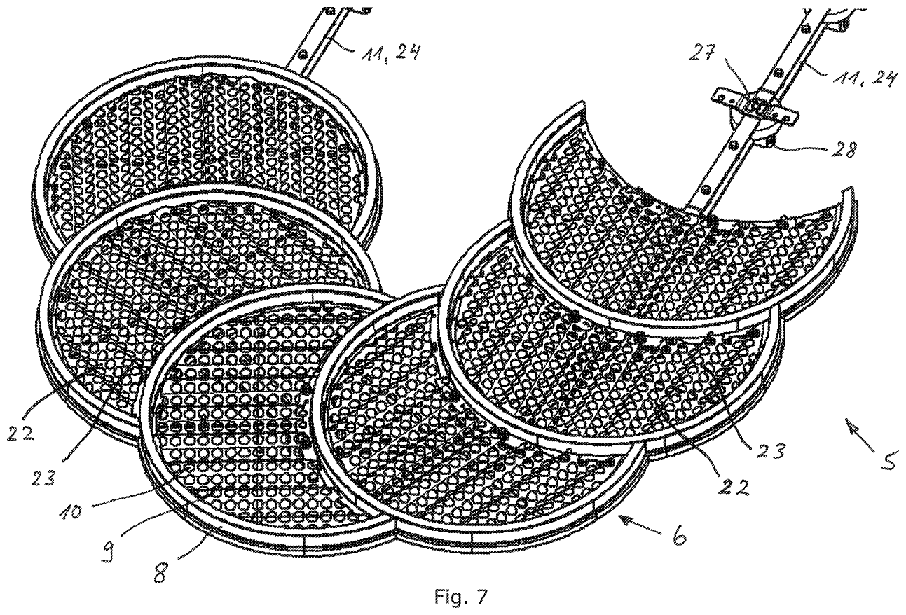

FIG. 7 shows a detail, corresponding to FIG. 5, of the continuous screening belt 5 from FIG. 3 from the lower deflection area of the continuous screening belt 5, wherein as a variation on FIG. 5 the orientation of the recesses 22 and the elevations 23 is parallel to the direction of motion of the continuous screening belt 5 during the upward movement of the screening panels 6.

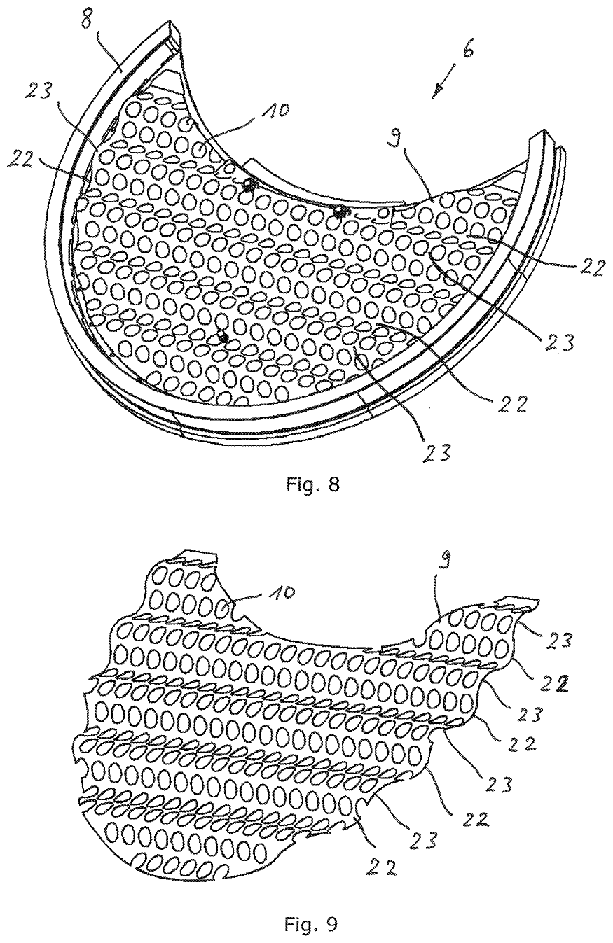

FIG. 8 shows a screening panel 6 of the continuous screening belt 5 from FIG. 2, with screening panel frame 8, screening surface 9, screening surface openings 10 and recesses 22 and elevations 23 running adjacent to one another across the screening surface 9. According to a general feature that is advantageous not only in this depicted exemplary embodiment, it is proposed that a screening surface 9 has both a plurality of recesses 22 running adjacent to one another across the screening surface 9 and a plurality of elevations 23 running adjacent to one another across the screening surface 9, wherein the recesses 22 and elevations 23 are arranged alternating with one another on the screening surface 9, as illustrated in the exemplary embodiment of FIG. 8. A wavy or wave-like profile of the screening surface 9 results from an alternating arrangement, which has advantages for the quantity of debris taken up by the screening surface 9, the extraction of the debris from the sluice channel 3 and the stability of the screening surface 9 and the screening panel 6.

FIG. 9 shows the screening surface 9 of the screening panel 6 in FIG. 8 without the screening panel frame 8. According to another general feature that is advantageous not only in this depicted exemplary embodiment, it is proposed that the number of recesses 22 or elevations 23 on each screening surface 9 is between 3 and 50, preferably between 4 and 40 and particularly preferably between 5 and 30. A profile of the screening surface 9 that is advantageous in practical application is achieved thereby. In FIG. 9, the screening surface 9 has four recesses 22 (or five, if the two ends are each counted as a half) and five elevations 23. Compared with a simple, i.e. non-wavelike curvature of the screening surface 9, regardless of whether this simple curvature were configured to be (one- or two-dimensionally) concave, convex or in another form, e.g. as an involute screen, a configuration of the screening surfaces 9 as a folding with a plurality of recesses 22 and elevations 23 has advantages for the quantity of debris taken up by the screening surface 9, the extraction of the debris from the sluice channel 3, the stability of the screening surface 9 and of the screening panel 6 and a smaller construction height of the screening surface 9 and the screening panel 6 perpendicular to the screening surface 9.

A corresponding, likewise generally advantageous implementation can include in the number of recesses 22 or elevations 23 on each screening surface 9 being between 2 and 20 per meter, preferably between 2.5 and 10 per meter and particularly preferably between 3 and 5 per meter relative to a flat cross-section of the screening surface 9 and measured in a direction transverse to the longitudinal extension of the recesses 22 or elevations 23.

According to a corresponding feature, it is proposed that the distance between the recesses 22 and elevations 23 on each screening surface 9 is between 5 cm and 50 cm, preferably between 10 cm and 40 cm and particularly preferably between 20 cm and 30 cm.

The recesses 22 and elevations 23 of the screening surface 9 that are depicted in the exemplary embodiment of FIG. 9 are linear, which represents a generally preferred embodiment. Such screening surfaces 9 can be manufactured particularly easily in that a wave-like folding is formed in a flat screening surface, thus without providing the screening surface 9 with a surface curvature.

It can also be provided in other embodiments, however, that the recesses 22 and elevations 23 of a screening surface 9 run in the shape of an arc, wherein the recesses 22 and elevations 23 span a flat reference plane. A dome-shaped curvature of the folded screening surface 9 arising over the screening surface 9 is thus created, wherein the curvature is preferably directed for static reasons to the inflow side. In a configuration of this kind the effective surface of the screening panel 6 is enlarged even further.

The design of the material, the construction, the support and the screening surface openings 10 of the screening surfaces 9 can be adapted to the respective application. The screening surfaces 9 can thus be manufactured from perforated or slotted sheet metal, from plastic or from wire fabric, for example. The screening surfaces 9 can be to a large extent self-supporting and/or can be supported by a screening panel frame 8 and/or can comprise a carrier or support structure fitted at or on the screening surfaces 9. Such a configuration can e.g. include that on a carrier or support structure, e.g. a solid wire, which structure is carried by a screening panel frame 8, a mesh material, e.g. a wire fabric or mesh, is attached to, preferably on the inflow side of the carrier or support structure for stability reasons. For particularly heavy loading the screening surfaces 9 can also be provided with stiffening elements.

The diameter or the size or clear width of the preferably mesh-like screening surface openings 10 (throughflow openings), through which the liquid or small elements not screened out of the sluice channel can flow through the screening surfaces 9, is adapted to the respective field of application. Advantageous values for this lie in the range of 5 mm to 10 cm. The mesh width of the screening panels or screening elements is preferably between 0.1 mm and 10 mm, in particular between 2 mm and 4 mm. In the typical area of use of such screening panels, the screening device 1 according to the invention offers the most significant advantages compared with the prior art.

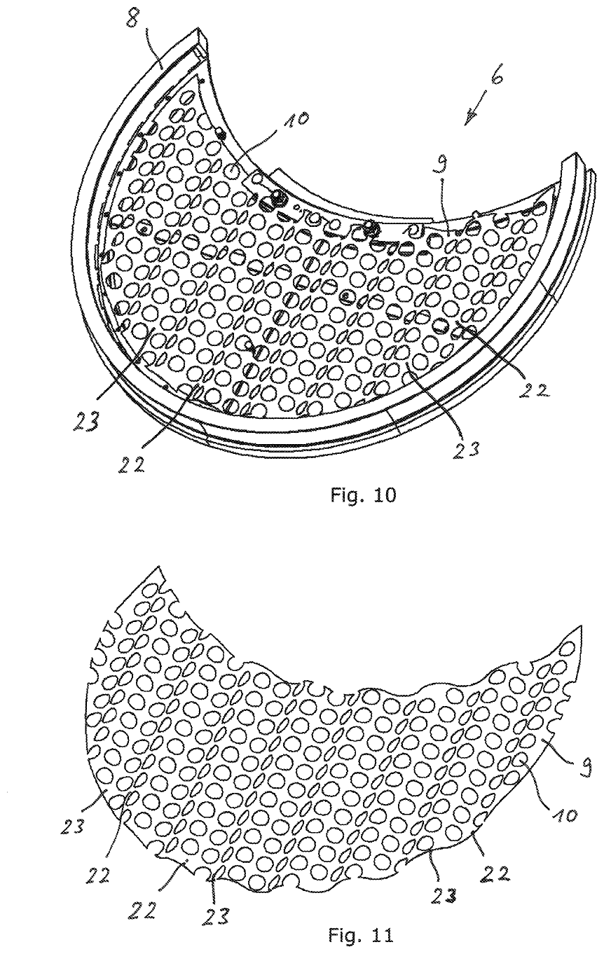

FIG. 10 corresponds to FIG. 8 and shows a screening panel 6 that is modified compared with FIG. 8 for the continuous screening belt 5 in FIG. 3. FIG. 11 shows the screening surface 9 of the screening panel 6 in FIG. 10 without the screening panel frame 8.

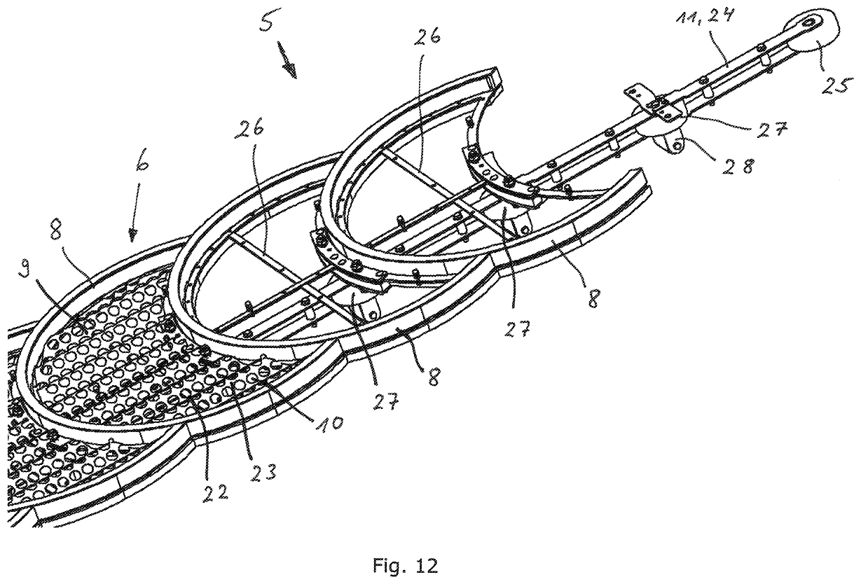

FIG. 12 shows a detail for FIG. 6, wherein some screening panel frames 8 are depicted without screening surfaces 9 inserted therein, so that the concatenation and support structure lying underneath can be recognized. Not only are the crescent-shaped configuration of the screening panel frames 8 carrying the screening surfaces 9 and the chain plates 24 and rollers 25 to be recognized here, which are used to concatenate and guide the screening panels 6, but also screening panel cross struts 26 in the screening panel frames 8, which are used to reinforce the screening panel frames 8 and/or as a carrier or support structure for the screening surfaces 9 and are preferably arranged on the clean water side of the screening surfaces 9. Also seen here are support rolls 28 arranged in chain links 27, which rolls act as rotating support elements for supporting the continuous screening belt 5 and the screening panels 6 on a screening belt support element.

FIG. 12 illustrates the articulated connection of the screening panels 6. In a preferred embodiment, the screening panels 6 are linked to one another by connection elements, e.g. connecting rods or chain plates 24. This has advantages in respect of the transmission of force for moving the continuous screening belt 5 in its circulatory motion 7 and for guiding the screening panels 6. It is particularly preferred here if the connecting elements form parts of a drive chain for the continuous screening belt 5, in particular link plates of a drive chain. This permits an advantageous design using a small number of necessary components. In the exemplary embodiment in FIG. 12, the crescent-shaped screening panels 6 are linked to one another via chain plates 24, wherein preferably the chain plates 24 in their totality form a drive chain for the continuous screening belt 5.

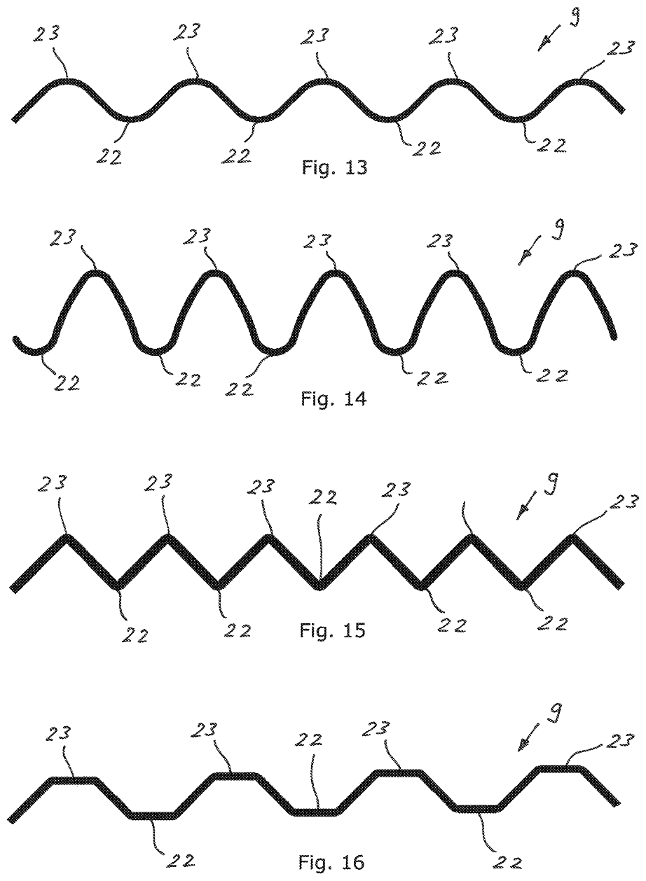

The configuration of the shape of the recesses 22 and/or elevations 23 of the screening surfaces 9 can be adapted to the respective application of the screening device 1. Advantageous embodiments can include in the cross-section of the recesses 22 and elevations 23 being configured on the screening surfaces folded in a wavelike, wavy, sawtooth-like or trapezoidal manner. FIGS. 13 to 16 show cross-sectional profiles of exemplary embodiments.

The profile of the screening surface 9 in FIG. 13 is folded in a wavelike manner, i.e. it corresponds substantially to a natural wave or sinusoidal shape.

The profile of the screening surface 9 in FIG. 14 is folded in a wavy manner, i.e. it corresponds approximately to a natural wave or sinusoidal shape. FIG. 14 shows a screening surface 9 folded in the manner of an involute.

In FIG. 15 the profile of the screening surface 9 is formed sawtooth-shaped, i.e. the folding is V-shaped, roof-shaped, zigzag-shaped or triangular. The pitch angle of both flanks of a recession 22 or elevation 23 in FIG. 15 is the same, but it can also be different.

In FIG. 16 the profile of the screening surface 9 is folded trapezoidally, i.e. the screening surface 9 is folded in a stepwise manner, wherein upper and lower sections, which are parallel to one another and are not inclined, alternate with oblique flanks, i.e. flanks not oriented perpendicular thereto.

It is common to all embodiments that the screening surface 9 is not smooth or level but is folded with wavy successive recesses 22 and elevations 23. These embodiments have the advantage that they have no acute-angled areas in the screening surface 9 in which any debris matter could adhere strongly.

According to an advantageous feature, it is proposed for the profile of the screening surface 9 that the ratio of the height of the recesses 22 and elevations 23, related to a level cross-section of the screening surface 9, on each screening surface 9 to the distance between the recesses 22 and elevations 23 on the screening surface 9 is between 0.1 and 2, preferably between 0.2 and 1.5 and particularly preferably between 0.3 and 1.0. This means that the folded screening surface 9 is relatively “flat”, thus the folding does not have too great an “amplitude”. Such screening surfaces 9 take up a lot of debris without it being caught in them permanently, they can be cleaned satisfactorily and are stable.

According to another advantageous feature, it is proposed that the absolute value, averaged across the screening surface 9 of a screening panel 6, of the flank angle of the recesses 22 and elevations 23 of the screening surface 9 that is measured transversely to the longitudinal extension of the recesses 22 and elevations 23, with regard to a level cross-section of the screening surface and not taking account of the sections of the screening surface 9 not running at an angle to a level cross-section of the screening surface 9, is between 10° and 80°, preferably between 20° and 70° and particularly preferably between 30° and 60°.

The flank angle (pitch/slope) of the recesses 22 and elevations 23 of the screening surface 9 that is averaged according to this feature over the longitudinal extensions (i.e. in the direction of the folding or transversely to the direction of the folds) results for a sine wave with the period length T and the amplitude A to arctan(4 A/T). For the exemplary embodiment in FIG. 13 with T=3.3 and A=0.5, a value of arctan(2/3.3)=31.2° results. In the exemplary embodiment of FIG. 14 this value is somewhat higher, because the profile is folded more strongly. In the exemplary embodiments of FIG. 15 and FIG. 16 this value is 45°, namely the edge steepness of the sawtooth shape shown, which can be greater or smaller, however.

Expressed another way, this exemplary feature means that the folding should not be rectangular, i.e. not stepped or staircase-shaped, i.e. the flank angle of the recesses 22 and elevations 23 should not be 90°. Although with very tight folding a rectangular configuration would have the advantage of a maximal effective screening surface 9 for a screening panel 6 of given dimensions, it has the disadvantage that the liquid does not flow well through the perpendicular flanks, so that the flow resistance is high. Furthermore, with such a design with a rectangular profile, in contrast to wavy configurations, no increase in size of the effective screening surface of 30% to 40% can be achieved with a small construction height, as the folding should not be too strongly pronounced for manufacturing and stability reasons.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A screening device for mechanically separating and extracting solid elements, solid bodies or solid matter from a stream of liquid of a liquid flowing in a sluice channel, in particular, a screen or filter grating for process, cooling water or effluent currents or for use in sewage treatment plants or hydroelectric power stations, the screening device comprising:
a plurality of screening panels, which are substantially oriented transversely to a flow direction of the stream of liquid, and which each have a screening surface with a plurality of screening surface openings, wherein the screening panels form a circulating, continuous screening belt, which are adapted to be partially immersed in the stream of liquid and in which a plurality of successive screening panels, arranged adjacent to one another in a direction of motion of the continuous screening belt, form a common screening surface in the sluice channel; and
a drive to drive the continuous screening belt in a circulatory motion,
wherein the screening panels are arranged successively in the continuous screening belt such that the circulatory motion of the continuous screening belt is kept completely within a single plane,
wherein pivot axes, about which the screening panels are pivoted at return points of the continuous screening belt, lie perpendicular to the common screening surface,
wherein the screening surface of the plurality of screening panels has a plurality of recesses and/or elevations running adjacent to one another across the screening surface, and
wherein, the plurality of screening panels have, on an inflow side thereof, a fish-lifting trough, the fish-lifting trough being arranged and designed such that, with respect to the screening panels moving upwards it is located at a lower end, with respect to the screening panels moving upwards it forms a liquid-filled collection recess for aquatic animals located in the particular screening panel, which collecting recess is lifted, in the movement direction of the continuous screening belt out of the stream of liquid together with the screening panel, together with the liquid contained in the collecting recess and together with aquatic animals caught in the liquid, when the continuous screening belt moves, and is emptied out into a collecting channel in the upper return area of the continuous screening belt in an emptying area of the screening device by tipping the screening panel and the collecting recess, the cleaning area of the screening device, which has a device for cleaning the debris from the screening surfaces is arranged so far behind the emptying area in the direction of motion of the continuous screening belt that the collecting recesses are emptied before they reach the cleaning area.

2. The screening device according to claim 1, wherein the screening device comprises screening panels, the screening surface of which has a plurality of recesses and elevations running adjacent to one another across the screening surface, wherein the recesses and elevations are arranged alternating with one another on the screening surface.

3. The screening device according to claim 1, wherein a cross-section of the recesses and elevations on the screening surfaces is configured to be folded in a wavelike, wavy, sawtooth-shaped or trapezoidal manner.

4. The screening device according to claim 1, wherein the plurality of recesses or elevations on each screening surface is between 3 and 50, preferably between 4 and 40 and particularly preferably between 5 and 30.

5. The screening device according to claim 1, wherein the plurality of recesses or elevations on each screening surface is between 2 and 20 per meter, preferably between 2.5 and 10 per meter and particularly preferably between 3 and 5 per meter, related to a level cross-section of the screening surface and measured in a direction transverse to the longitudinal extension of the recesses or elevations.

6. The screening device according to claim 1, wherein a distance between the recesses and elevations on each screening surface is between 5 cm and 50 cm, preferably between 10 cm and 40 cm and particularly preferably between 20 cm and 30 cm.

7. The screening device according to claim 1, wherein a height of the recesses and elevations on each screening surface is between 2 cm and 20 cm, preferably between 4 cm and 15 cm and particularly preferably between 6 cm and 10 cm, related to a level cross-section of the screening surface.

8. The screening device according to claim 1, wherein a ratio of the height of the recesses and elevations, relative to a level cross-section of the screening surface, on each screening surface to the distance between the recesses and elevations on the screening surface is between 0.1 and 2, preferably between 0.2 and 1.5 and particularly preferably between 0.3 and 1.0.

9. The screening device according to claim 1, wherein an absolute value, averaged across the screening surface of a screening panel, of the flank angle of the recesses and elevations of the screening surface that is measured transversely to the longitudinal extension of the recesses and elevations, with regard to a level cross-section of the screening surface and not taking account of the sections of the screening surface not running at an angle to a level cross-section of the screening surface, is between 10° and 80°, preferably between 20° and 70° and particularly preferably between 30° and 60°.

10. The screening device according to claim 1, wherein the recesses and elevations of a screening surface are linear.

11. The screening device according to claim 1, wherein the recesses and elevations of a screening surface run in an arc.

12. The screening device according to claim 1, wherein a plane of the circulatory motion of the screening panels is arranged substantially perpendicular to the flow direction of the stream of liquid.

13. The screening device according to claim 1, wherein a part of the circulating continuous screening belt moving upwards and a part of the circulating continuous screening belt moving downwards each cover roughly a right and left half of the stream of liquid.

14. The screening device according to claim 1, wherein the screening device further comprises a cleaning area with a spray device for cleaning the screening panels conveyed upwards out of the stream of liquid prior to their reimmersion in the stream of liquid, and wherein the cleaning area debris adhering to the screening surfaces and extracted from the stream of liquid is removed from the screening panels by spraying of the screening panels of the continuous screening belt lifted out of the stream of liquid via water or compressed air spray jets and is collected by a debris collecting sluice channel arranged on the side of the continuous screening belt opposite the spray jets, and wherein the debris sprayed off is carried in the direction of the debris collecting sluice channel by the inclined flanks of the elevations and/or recesses in the screening surfaces.

15. The screening device according to claim 1, wherein the screening device is adapted for mechanically separating and extracting solid elements, solid bodies or solid matter from the stream of liquid of a liquid flowing in a sluice channel, in particular, as screen or filter grating for process, cooling water or effluent currents or for use in sewage treatment plants or hydroelectric power stations.
